(19) United States
(12) Patent Application Publication
(10) Pub. No.: US 2021/0192818 A1
(43) Pub. Date: Jun. 24, 2021

(54) INFORMATION PROCESSING DEVICE, INFORMATION PROCESSING METHOD, AND NON-TRANSITORY RECORDING MEDIUM STORING THEREIN INFORMATION PROCESSING PROGRAM

(71) Applicant: Lambda Systems Inc., Tokyo (JP)

(72) Inventor: Shinji Unami, Tokyo (JP)

(21) Appl. No.: 17/120,352

(22) Filed: Dec. 14, 2020

(30) Foreign Application Priority Data
Dec. 19, 2019 (JP) 2019-228915

(51) Int. Cl. G06T 11/60

(52) U.S. Cl. CPC G06T 11/60; G06T 2200/24

(57) ABSTRACT

The information processing device, information processing method, and information processing program which can reduce the cost concerning grant of the effect according to a character string are provided. An information processing device includes: a storage unit configured to store a predetermined character string and an effect corresponding to the predetermined character string; an acquisition unit configured to acquire character data; a determination unit configured to determine whether all or a part of character string included in the character data acquired by the acquisition unit are stored in the storage unit; a generation unit configured to generate image data including the effect when the determination unit determines that all or a part of the character string is stored in the storage unit; and a providing unit configured to provide the image data generated by the generation unit.

### TECHNICAL FIELD

This disclosure relates to an information processing device, an information processing method, and a non-transitory recording medium storing therein an information processing program.

### BACKGROUND

Conventionally, there have been techniques in which display effects are given automatically to character strings included in character data. For example, Japanese Laid-Open Patent Application Publication No. 2007-3348141 (JP 2007-334841 A) discloses a notification device that captures input video signal as an image, extracts character information from the image, converts the extracted character information into numerical data, generates a display screen from the converted numerical data, and outputs a video, and a technique in which the video output by the notification device is displayed and a display effect is added to the displayed video according to importance of values of the numerical data.

However, in conventional techniques, although it is possible to add a display effect to the displayed image according to importance of values of the numerical data obtained by converting the character information, a specific effect according to a predetermined character string is not automatically added. In some instances, an operator's manual operation of adding the effect is required, and the cost such as the operator's labor cost may increase.

It could therefore be helpful to provide an information processing device, an information processing method, and an information processing program capable of reducing the cost of adding an effect according to a character string.

### SUMMARY

We thus provide:

(1) An information processing device includes a storage unit configured to store a predetermined character string and an effect corresponding to the predetermined character string, an acquisition unit configured to acquire character data, a determination unit configured to determine whether or not all or a part of character string included in the character data acquired by the acquisition unit is stored in the storage unit, a generation unit configured to generate image data including the effect when the determination unit determines that all or a part of the character string is stored in the storage unit, and a providing unit configured to provide the image data generated by the generation unit.
(2) The information processing device may further include a UI providing unit configured to provide a user interface for setting a predetermined character string and the effect, in which the storage unit stores a predetermined character string and the effect based on setting by an input on the user interface provided by the UI providing unit.
(3) The storage unit may store a character string that expresses an emotion of a person as the predetermined character string, and the generation unit generates image data including an effect corresponding to the emotion.
(4) The storage unit may store a character string that expresses an environment as the predetermined character string, and the generation unit generates image data including an effect corresponding to the environment.
(5) The generation unit may generate image data including an effect that decorates a character string included in the character data.
(6) The storage unit may store effects corresponding to a first character string that expresses a first state as the predetermined character string and a second character string that expresses a second state, and an effect corresponding to a combination of the first character string and the second character string, the determination unit determines whether or not a part of a character string included in the character data is included in the first character string and the second character string, and the generation unit generates image data including an effect corresponding to the combination when the determination unit determines that a part of the character data is included in the first character string, and another part of the character data is included in the second character string.
(7) The acquisition unit may acquire an image including character data, and the determination unit extracts character data from the image acquired by the acquisition unit, and determines whether all or a part of a character string included in the extracted character data is stored in the storage unit.
(8) The generation unit may generate image data concerning a ticker image including the effect, and the providing unit provides the image data to a processing unit which processes a ticker image.
(9) An information processing method executed in an information processing device includes storing a predetermined character string and an effect corresponding to the predetermined character string, acquiring character data, determining whether or not all or a part of a character string included in character data acquired is stored, generating image data including the effect when a determination unit determines that all or a part of the character string is stored, and providing the generated image data.
(10) A non-transitory recording medium storing therein an information processing program causes a computer to execute the functions of: storing a predetermined character string and an effect corresponding to the predetermined character string, acquiring character data, determining whether or not all or a part of a character string included in character data acquired is stored, generating image data including the effect when it is determined that all or a part of the character string is stored, and providing the generated image data.

An information processing device stores a predetermined character string and an effect corresponding to the character string, acquires character data, and determines whether all or a part of the character string included in the acquired character data is stored, and when it is determined that all or a part of the character string is stored, generates image data including effects, and provides the generated image data, thereby enabling a cost of adding the effect according to the character string to be reduced.

### BRIEF DESCRIPTION OF THE DRAWINGS

FIG. 1 is a block diagram showing an example of a software configuration of an information processing device.

FIG. 2 is a diagram showing an example of an effect setting screen used in the information processing device.

FIG. 3 is a diagram showing an example of image data including effects corresponding to emotional characters provided in the information processing device.

FIG. 4 is a diagram showing an example of image data including effects corresponding to environmental characters provided in the information processing device.

FIG. 5 is a block diagram showing an example of a hardware configuration of the information processing device.

FIG. 6 is a flowchart showing an example of an operation of the information processing device.

### DETAILED DESCRIPTION

Hereinafter, with reference to the drawings, examples of an information processing device, an information processing method, and an information processing program will be described in detail.

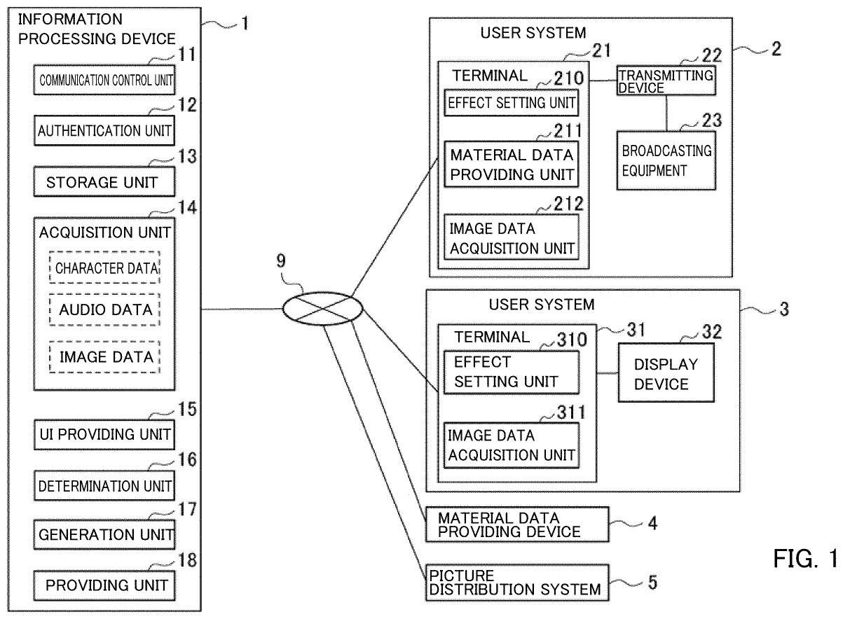

First, functions of the information processing device will be described with reference to FIG. 1. FIG. 1 is a block diagram showing an example of a software configuration of an information processing device.

In FIG. 1, an information processing device 1 is communicably connected to a terminal 21, a terminal 31, a material data providing device 4, and an image distribution system 5 via a network 9. FIG. 1 illustrates a connection destination of the information processing device 1 by way of example, and does not limit the connection destination of the information processing device 1.

The information processing device 1 has functional units configured as a communication control unit 11, an authentication unit 12, a storage unit 13, an acquisition unit 14, a UI providing unit 15, a determination unit 16, a generation unit 17, and a providing unit 18. Each of the above-mentioned functional units of the information processing device 1 will be described as a functional module executed by an information processing program (software).

The communication control unit 11 controls communication between the information processing device and each of the terminal 21, the terminal 31, the material data providing device 4 and the image distribution system 5 (hereinafter, all or some of the terminal 21, the terminal 31, the material data providing device 4, and the image distribution system 5 may be referred to as “terminal 21 and others”), which are connected with each other via a network 9.

The authentication unit 12 authenticates a user who uses the terminal 21 and others by using the communication control unit 11. For example, a user who uses the terminal 21 is a person who has an authority to use functions provided by the information processing device 1 communicably connected to the terminal 21. The user who uses the terminal 21 is an operator who operates the terminal 21, for example. The authentication unit 12 authenticates a user having user authority by, for example, a login ID and a password assigned to each user. A user in the example may not be the specified individual. For example, when one login ID is sequentially used by a plurality of people, the user can be the person who is currently using the user ID. The authentication unit 12 may use an authentication method other than the login ID and password authentication (for example, biometric authentication, magnetic card authentication).

The storage unit 13 stores a plurality of character strings and effects corresponding to the respective character strings. A character string is a set of one character or a plurality of characters. The characters are, for example, hiragana, katakana, Chinese characters, alphabetic characters, numbers, symbols, codes, and the character string may be a combination of these characters. In addition, a character string may be a word or a combination of words. The character string in the example is a character string that expresses a predetermined state. A character string that expresses a predetermined state is a character string that may be able to remind a predetermined state from the character string when a person looks at the character string. A predetermined state is a state of an emotion of a person, or a state of an environment, for example. The predetermined state includes states of things (broken state, unraveled state, or reduced state, for example), states associated with activities of a person (sports game situation, congestion state, or browsing state of Web pages, for example) may be included. In the following description, as character strings that express a predetermined state, a character string that expresses a state of an emotion of a person and a character string that expresses a state of an environment will be described as examples.

Character String that Expresses a Person's Emotional State

A character string that expresses an emotional state of a person is, for example, a character string that expresses joy, excitement, sadness, anger, and is “exhilarated,” “excited,” “happy,” “I did it,” “!,” “impressed,” “excited,” “shocked,” “(° o °),” “surprised,” “dejected,” “↓”, “disappointed,” “orz,” “depressed,” “screaming,” “frustrated,” “ANGER,” and “cold.” These character strings that express a person's emotional state can remind emotions of a person. For example, a sentence “I am excited.” includes words “I,” “am” and “excited,” and the character string “excited” that expresses a person's emotional state reminds a state where people are more excited than when other strings remind a state where people are excited.

Character String that Expresses a State of an Environment

The environment may refer to an external event such as society or nature surrounding a person. The character strings that represent the state of the environment are, for example, temperature (such as the temperature (Celsius, Fahrenheit, or character strings that express a temperature)), seasons (spring, summer, autumn and winter), time, and calendar months (January to December)), end of seasons (summer solstice, winter solstice, spring equinox, autumn equinox), regions (including country names, prefecture names, municipalities, local names, for example), and “hot day,” “15° C.,” “June,” “summer solstice” and “northern country,” for example. The character string that expresses the state of the environment may be an onomatopoeia that symbolically represents a sound or voice of the natural world, or the state or movement of things with a sound. These character strings that express states of an environment can remind the states of the environment. For example, the sentence “Today was a hot day” includes the words “today,” “was” and “a hot day,” and the character string “a hot day” that expresses the state of the environment reminds a condition of sweltering temperature compared to other character strings.

In the above description, as the character string that expresses a predetermined state, the character string that expresses the emotional state of a person and the character string that expresses the state of the environment are illustrated by way of example. However, character string that expresses the predetermined state is not limited to these character strings. For example, some common nouns and proper nouns can image a predetermined state when a person looks at the character string. For example, some character strings such as a person's occupation, job title, and position remind the person's condition (for example, strictness, respect, authority, and friendliness). For example, the character string “prime minister” or “premier” may remind a state of dignity as the head of multiple administrative organization with administrative authority. In addition, there is a character string that reminds a predetermined state even in a proper noun such as a person's name, a place name, or a product name. For example, the prime minister's specific name may remind the person's personality and behavior. In addition, a common noun “glasses” may remind a hard-working person. In other words, the character string that expresses a predetermined state does not always remind all people of the same state, and may be a character string in which the state reminded by each person is different.

An effect is a decoration of a character string that expresses a state reminded by the character string. For example, the effect is to decorate the character itself by giving a color to each character or changing the size of the character. Further, the effect may add decoration such as an underline, a frame line, a balloon, a frame (outer frame), or a predetermined mark to the character string. In addition, the effect may include a switch 2D (Dimensional)/3D display in the character string, add effects such as 3D motion (video) or 3D rotation to the character string, add ruby, or decorate the character string with multiple lines. The effect may include an effect to which sound is added and output.

The effect corresponding to the character string is the decoration corresponding to each character string. For example, in a character string that expresses a person's emotional state, the character string that expresses anger or excitement is colored red, while the character string that expresses sadness is colored blue, which may allow the state of the emotion to be more strongly impressed. In addition, it may be possible to express the state of the environment in an easy-to-understand manner by adding an effect of adding warm or cool colors to the temperature and seasons. By adding an effect corresponding to each character string, for example, the impression of the character string can be strengthened or the meaning of the character string can be easily understood. Even if a character string is the same as another character string, the state reminded from the character string can be changed by effects added to the character strings. For example, when a warm color system is decorated to the same common noun, while a warm state can be reminded, a cold state can be reminded when a cold color system is decorated.

The storage unit 13 may store a character string and an effect in association with each other in advance. The storage unit 13 may store a plurality of effects in association with one character string, or may associate and store one effect with respect to the plurality of character strings.

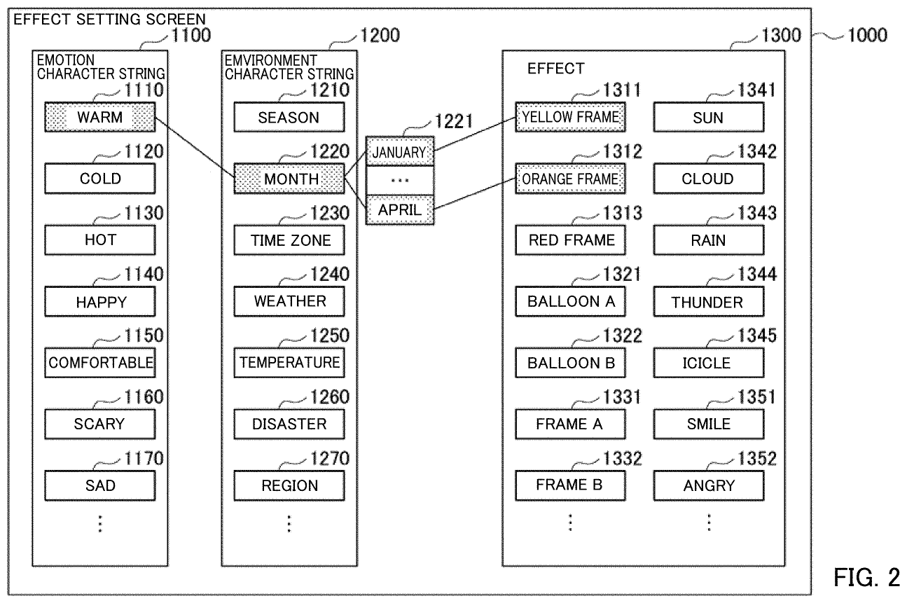

The acquisition unit 14 acquires material data including a character string. The material data is, for example, character data including a character string, audio data including audio information, graphic data represented by vector data, image data including image information, or a combination thereof. The acquisition unit 14 acquires material data from the inside of the information processing device 1 (for example, the storage unit 13) or the outside of the information processing device 1. The FIG. 2 illustrates when the acquisition unit 14 acquires material data from the material data providing unit 211 of the terminal 21 or the material data providing device 4. In this example, when the term “acquisition” of data is used, it may be a pull-type data acquisition such as download, or a push-type data acquisition for receiving data transmitted from another device. For example, the acquisition unit 14 may provide a UI for inputting or selecting material data to be provided to the terminal 21, and the user who uses the terminal 21 may acquire the material data by operating the UI displayed on the terminal 21. Further, the acquisition unit 14 may acquire the material data by reading the material data stored in the material data providing device 4.

The character data may include, for example, time information, weather information, traffic information, breaking news and subtitles. Further, the character data may include input data manually input from a keyboard (not shown) of the terminal 21.

The audio data may include character information generated by voice recognition. The audio data are, for example, a sub-audio of a television broadcast. Further, the image data may include character information generated by image recognition. The image data are, for example, still image information and moving image information (including animation of a plurality of still images). The image data may include audio. In the example, a situation where voice recognition or image recognition is executed by the determination unit 16 described later is illustrated by way of examples.

The UI providing unit 15 provides a user interface (UI) to set a predetermined character string in association with an effect. The UI providing unit 15 is, for example, a Web server that provides a Web page to the terminal 21. The UI provided by the UI providing unit 15 is displayed on the Web browser, allowing the terminal 21 and others to set a predetermined character string and the effect corresponding to the character string. The character string and the effect corresponding to the character string are set, allowing the terminal 21 and others to set in advance a state that can be reminded by the character string. The storage unit 13 stores the predetermined character string and the effect corresponding to the character string based on the UI settings provided by the UI providing unit 15. The details of UI provided by the UI providing unit 15 are illustrated by way of examples in FIG. 2.

The determination unit 16 determines whether or not all or a part of the character string included in the character data acquired by the acquisition unit 14 is stored in the storage unit 13. For example, when the character string is a sentence configured with a plurality of words, the determination unit 16 extracts a plurality of words included in the character string, and determines whether or not each extracted word is stored in the storage unit 13. The determination unit 16 may perform voice recognition of the voice data acquired by the acquisition unit 14 to generate a character string, and determine whether or not the generated character string is stored in the storage unit 13. Further, the determination unit 16 may perform image recognition of the image data acquired by the acquisition unit 14 to generate a character string, and determine whether or not the generated character string is stored in the storage unit 13.

The determination unit 16 may determine whether or not the first character string and the second character string included in the character data acquired by the acquisition unit 14 are stored in the storage unit 13.

The first character string and the second character string are described. The first character string is a character string that expresses a first state, and the second character string is a character string that expresses a second state. For example, the character string that expresses the emotional state of a person can be used as the first character string, and the character string that expresses the state of the environment can be used as the second character string. The second character string is a character string different from the first character string. However, a part of the first character string may match the second character string. For example, the first character string may be “Akiru” and the second character string may be “Aki.”

The determination unit 16 determines whether or not the character string included in the first character string is stored in the character string included in the character data acquired by the acquisition unit 14. Further, the determination unit 16 determines whether or not the character string included in the second character string is stored in the character string included in the character data acquired by the acquisition unit 14. In other words, the determination unit 16 can determine whether or not the character string included in the first character string exists and whether or not the character string included in the second character string exists in the character string included in the acquired character data. The determination unit 16 can determine, for example, when a character string exists in both the first character string and the second character string, when a character string exists in only one of the first character string and the second character string, and when a character string does not exist in either the character string or the second character string.

For example, it is assumed that the character string included in the character data acquired by the acquisition unit 14 is “cold for August,” and “August” is stored as the first character string as the second character string, and “cold” is stored in the storage unit 13. The determination unit 16 can determine that the character string “it is cold for August” has a character string in both the first character string and the second character string. Similarly, it is assumed that the character string included in the character data acquired by the acquisition unit 14 is “warm for December,” “December” is stored as the first character string, and “warm” is stored as the second character string. The determination unit 16 can determine that the character string “warm for December” has a character string in both the first character string and the second character string. As an actual sensible temperature, it is expected that “cold” in August is lower than “warm” in December. In other words, the contents of the character strings that express the states may be grasped when they are combined with each other. The determination unit 16 sometimes can correctly determine the content of the character string by determining whether or not the character string included in the first character string is stored in the character string included in the character data acquired by the acquisition unit 14.

The determination unit 16 may be able to determine when both the first character string and the second character string are included, when either one is included, or when neither is included. In the examples described later, when both the first character string and the second character string are included will be described as an example.

When the determination unit 16 determines that all or a part of the character string is stored in the storage unit 13, the generation unit 17 generates image data including an effect corresponding to the stored character string. The image data including the effect is, for example, image data including an effect for adding a color corresponding to a character string. The generation unit 17 may generate image data including an effect of decorating the character itself as described above, or may generate image data including an effect of adding decoration such as an underline to the character string.

When the determination unit 16 determines that a part of the character data is included in the first character string and the other part of the character data is included in the second character string, the generation unit 17 may generate first image data including an effect corresponding to the combination of the character string and the second character string. The effect corresponding to the combination of the first character string and the second character string is an effect when both the first character string and the second character string are included in the character string. The generation unit 17 can generate image data including an effect different from the effect when only one of the first character string and the second character string is included.

The generation unit 17 may generate image data including an effect of replacing a character string with a predetermined mark, for example. For example, when the character string includes the character string “cold,” the generation unit 17 may generate image data including an effect of displaying an image of an icicle instead of the character string “cold.”

Further, the generation unit 17 may generate ticker data as image data including effects. A ticker is character information, symbol information, graphic information, audio information, or image information that is superimposed, inserted, or combined with an original image such as a moving image or a still image (hereinafter, may be referred to as “superimposition and others”), or information of a combination thereof (hereinafter, may be referred to as “character information and others”). The original image is, for example, a television image used for television broadcasting, a moving image used in a moving image distribution service, a display image displayed on a large display device. The ticker data is data used for a ticker that is, for example, superimposed on the original image. The ticker data is created based on the material data and provided to the user system 2 owned by the user. The ticker data is, for example, superimposed on a part or all the original image in the user system 2 and is, for example, broadcasted, distributed or displayed. The ticker may be called, for example, a caption, a subtitle, a ticker, an alert and a superimpose, depending on, for example, an area, a content and a format to be used, and is included in the ticker.

Further, the generation unit 17 may generate vector data before being rasterized as image data. In other words, the image data generated by the generation unit 17 may be data before being converted into an image or data after being converted into an image.

The providing unit 18 provides the image data generated by the generation unit 17 to the terminal 21 and others connected via the network 9. The image data provided by the providing unit 18 is displayed, for example, in a moving image used in a television broadcast or a moving image distribution service, a display image displayed on a large display device. The provided data provided by the providing unit 18 is, for example, communication data encoded according to a communication protocol via the network 9, or may be encryption data encrypted by a predetermined encryption method.

The providing unit 18 may provide the image data acquisition unit 212 of the terminal 21 with ticker data in a data format corresponding to the input of the transmitting device 22 as image data. For example, the providing unit 18 may provide a signal conforming to the video electrical standard of a serial digital interface (SDI; Serial Digital Interface) or data including the signal. The providing unit 18 may transmit the ticker data at the transmission timing of the transmitting device 22. Further, the providing unit 18 may transmit ticker data in response to a request from the user system 2.

The user system 2 includes the terminal 21, the transmitting device 22, and broadcasting equipment 23. The user system 2 exemplifies a system that transmits a ticker from the transmitting device 22 to the broadcasting equipment 23, provides material data including a character string to the information processing device 1, and acquires the ticker data from the information processing device 1. The terminal 21 includes an effect setting unit 210, a material data providing unit 211, and an image data acquisition unit 212.

The effect setting unit 210 is, for example, a Web browser for displaying the UI provided by the UI providing unit 15 and setting a character string and an effect corresponding to the character string. The user may select a character string and an effect via a Web browser and associate the selected character string with the effect.

The material data providing unit 211 provides the material data to the information processing device 1. The material data providing unit 211 may provide the material data by operating the UI provided by the acquisition unit 14 by a user (operator) who uses the terminal 21. For example, in the UI provided by the acquisition unit 14, the user may provide the material data by selecting a file including the material data or by inputting the character data from a keyboard.

The image data acquisition unit 212 acquires image data such as ticker data generated by the information processing device 1 and outputs the image data to the transmitting device 22. For example, the image data acquisition unit 212 may acquire the ticker data by acquiring a signal indicating that the ticker data can be provided from the providing unit 18. When there are a plurality of generated ticker data, the image data acquisition unit 212 acquires a plurality of generated ticker data. The image data acquisition unit 212 may display the acquired plurality of ticker data to the user in a selectable manner and output the selected ticker data to the transmitting device 22.

The transmitting device 22 is a device that transmits a ticker image to the broadcasting equipment 23, and includes an image input unit (not shown) that inputs ticker data, a frame buffer (not shown) to temporarily store the ticker data, and an image output unit (not shown) that outputs ticker data as a frame image (ticker image) of a predetermined image system. The transmitting device 22 outputs the ticker image temporarily stored in the frame buffer to the broadcasting equipment 23 in response to instructions from a device that controls the transmission timing.

The broadcasting equipment 23 is installed in a broadcasting station of television broadcasting, and superimposes a ticker image transmitted from the transmitting device 22 on the original image to generate an image including the ticker used for television broadcasting.

By providing the material data, the user system 2 can acquire image data including an effect corresponding to the character string included in the material data, which allows a cost of generating the image data such as the ticker data including the effect to be reduced.

The user system 3 is a system that displays an image on a display device 32, and exemplifies a system that acquires image data from the information processing device 1. The user system 3 includes the terminal 31 and the display device 32. The terminal 31 includes an effect setting unit 310 and an image data acquisition unit 311.

Similarly to the effect setting unit 210, the effect setting unit 310 is, for example, a Web browser that displays the UI provided by the UI providing unit 15 and setting a character string and an effect corresponding to the character string.

The image data acquisition unit 311 acquires the image data generated by the information processing device 1 and outputs the image data as display data that can be displayed on the display device 32. For example, the image data acquisition unit 311 may acquire the image data by acquiring a signal indicating that the image data can be provided from the providing unit 18. Further, when the generated image data are plural, the image data acquisition unit 311 acquires the generated plural image data and displays the acquired plurality of image data to the user in a selectable manner. Further, the selected image data may be output to the display device 32. Further, the image data acquisition unit 311 may convert the acquired image data into display data (for example, a video signal) that can be displayed on the display device 32 and output the acquired image data to the display device 32.

The display device 32 is a device that displays the display data output from the image data acquisition unit 311. The display device 32 is, for example, a large display installed in a public place, a digital signage installed in a commercial facility.

Providing the material data allows the user system 3 to acquire image data including an effect corresponding to the character string included in material data, reducing a cost to generate the image data such as the ticker data including the effect to be reduced.

The material data providing device 4 exemplifies a device that provides material data including a character string to the information processing device 1. The material data providing device 4 is, for example, a network storage service that stores material data in a readable manner. The material data providing device 4 may provide the material data by allowing the material data stored by a predetermined network address and password to be readable, for example. Since the information processing device 1 can generate image data including an effect corresponding to the character string included in the material data provided by the material data providing device 4, which allows a cost required to generate the image data to be reduced.

The image distribution system 5 is a system that distributes an image (moving image or still image) based on the image data provided by the providing unit 18 to a distribution destination (not shown) in real time or on demand. The image distribution system 5 is a moving image distribution system that distributes moving images. The image distribution system 5 may distribute the image data itself, or may distribute an image on which the image data is superimposed.

The network 9 is, for example, the Internet. The network 9 may include, for example, a base station of a mobile phone, an access point of a wireless LAN.

In addition, each of functional units configured with the communication control unit 11, the authentication unit 12, the storage unit 13, the acquisition unit 14, the UI providing unit 15, the determination unit 16, the generation unit 17, and the providing unit 18 included in the information processing device 1 shows an example of the functional units of the information processing device 1, and does not limit the function which the information processing device 1 has. For example, the information processing device 1 does not need to have all the above-mentioned functional units, and may have some of the functional units. Further, the information processing device 1 may have functions other than the above. The information processing device 1 may have, for example, an input function to input information and an output function to notify the operating state of the device by an LED lamp.

Further, each of the above-mentioned functional units included in the information processing device 1 has been described as executed by software as described above. However, at least one or more of the functional units included in the information processing device 1 may be executed by hardware.

Further, any of the above-mentioned functional units included in the information processing device 1 may be implemented by dividing one functional unit into a plurality of functional units. Further, any two or more of the above-mentioned functional units included in the information processing device 1 may be integrated into one functional unit. In other words, FIG. 1 shows the functions of the information processing device 1 represented by functional blocks, and does not show, for example, that each of the functional units is configured with a separate program file.

Further, the information processing device 1 may be a device implemented by one housing or a system implemented by a plurality of devices connected via a network, for example. For example, the information processing device 1 may execute a part or all its functions by another virtual device such as a cloud service provided by a cloud computing system. That is, the information processing device 1 may execute at least one or more of the above-mentioned functional units in another device. Further, the information processing device 1 may be a general-purpose computer such as a desktop PC, or may be a dedicated device having limited functions.

Next, the setting of the effect corresponding to the character string will be described with reference to FIG. 2. FIG. 2 is a diagram showing an example of the effect setting screen 1000 used in the information processing device 1.

The effect setting screen 1000 is an example of the UI provided by the UI providing unit 15, is displayed on a Web browser such as the terminal 21, and is operated by the user. The effect setting screen 1000 includes an emotion character string setting unit 1100, an environment character string setting unit 1200, and an effect setting unit 1300.

The emotion character string setting unit 1100 is a setting screen for setting a character string that expresses an emotion of a person. The emotion character string setting unit 1100 has, for example, selection units such as “warm” 1110, “cold” 1120, “hot” 1130, “happy” 1140, “comfortable” 1150, “scary” 1160 and “sad” 1170. The character string of each of the selection units may be input by the user in advance. The drawing shows a state in which “warm” 1110 is selected and set by the user.

The environment character string setting unit 1200 is a setting screen for setting a character string that expresses an environment. The environment character string setting unit 1200 has, for example, selection units such as “season” 1210, “month” 1220, “time zone” 1230, “weather” 1240, “temperature” 1250, “disaster” 1260 and “region” 1270. The character string of each of the selection units may be input by the user in advance. The drawing shows a state in which “month” 1210 is selected and set by the user. When “month” 1210 is selected, a pull-down 1221 for selecting a month is displayed, and “January” to “December” can be set. The drawing shows a state in which “January” and “April” are selected and set by the user.

The effect setting unit 1300 is a setting screen for setting an effect corresponding to a character string set in at least any one of the emotion character string setting unit 1100 and the environment character string setting unit 1200. The effect setting unit 1300 includes, for example, selection units such as “yellow frame” 1311, “orange frame” 1312, “red frame” 1313, “balloon A” 1321, “balloon B” 1322, “frame A” 1331, “frame B” 1332, “sun” 1341, “cloudy” 1342, “rain” 1343, “thunder” 1344, “icicle” 1345, “smile” 1351 and “angry” 1352. The content of the effect of each selection unit may be preset by the user. The figure shows a state in which “yellow frame” 1311 and “orange frame” 1312 are selected and set by the user. Note that “sun” 1341, “cloudy” 1342, “rain” 1343, “thunder” 1344, “icicle” 1345, “smile” 1351 and “anger” 1352 are effects for adding images (still images or moving images) that expresses each of them.

The drawing shows when the emotion character string setting unit 1100 as the first character string and the environment character string setting unit 1200 as the second character string are set in association with each other. When associating the first character string “warm” 1110 with the second character string “month” 1220, a user can connect “warm” 1110 and “month” 1220 (“January” and “April”) with a line segment. In addition, the user can connect “January” shown in the pull-down 1221 and “yellow frame” 1311 with a line segment, and further connect “April” shown in the pull-down 1221 and “orange frame” 1312 with a line segment. This allows an effect to be set when the character string includes both the character string “warm” and the character string “January” or “April.” For example, for a character string of “warm for January,” it is possible to automatically generate image data including an effect of adding a yellow frame that can describe the warmth to the character string. In addition, for the character string “warm day in April,” image data including an effect of adding an orange frame to the character string that can describe that the redness is stronger and the temperature is higher than yellow can be automatically generated. As a result, even if the character string uses the same emotional character “warm,” image data including effects that match the actual temperature can be automatically generated in January and in April.

The drawing shows when the emotion character string as the first character string and the environment character string as the second character string are associated with each other to set the corresponding effect. For example, an effect associated with only an emotion character string may be set. Similarly, an effect associated with only an environment character string may be set.

Further, in the example, a situation where two character strings that express the two states of the first character string and the second character string are associated with each other is illustrated. However, for example, three or more character strings may be associated with each other. Further, any number of character strings may be associated with each other.

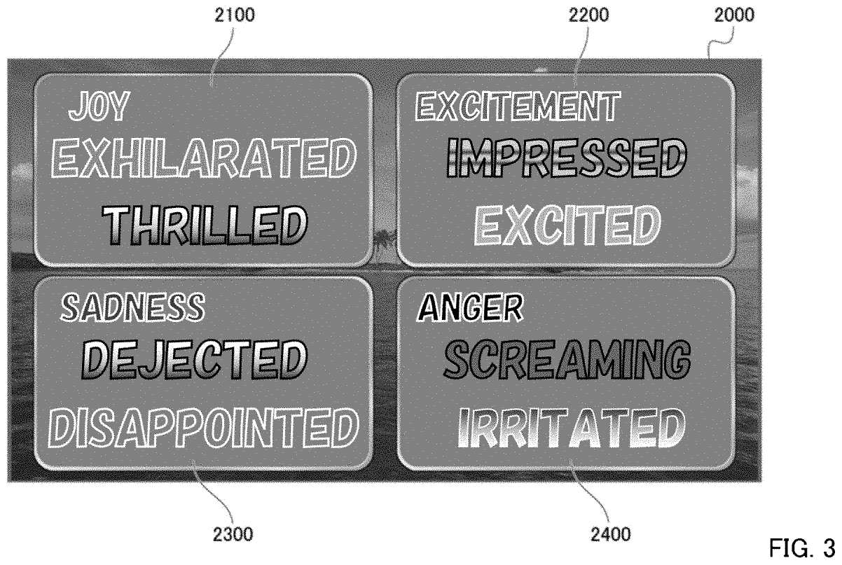

Next, the effect corresponding to the emotional character will be described with reference to FIG. 3. FIG. 3 is a diagram showing an example of image data including an effect corresponding to an emotion character provided in the information processing device 1.

In FIG. 3, the display screen 2000 has a joy image 2100, an excitement image 2200, a sadness image 2300 and an anger image 2400. The joy image 2100, the excitement image 2200, the sadness image 2300, and the anger image 2400 are display examples of image data including the effect generated by the generation unit 17. The colors of the characters in the drawing are displayed in grayscale. However, each of the characters has colors described below.

The joy image 2100 shows the effect corresponding to the character strings of “exhilarated” and “excited.” The effect corresponding to the character string “exhilarated” effect expresses an exhilarated emotion with a character having a cool-based color. In addition, the effect corresponding to the character string “excited” expresses joy in 3D display with a character having a warm-based color. The excitement image 2200 shows the effect corresponding to the character strings “impressed” and “excited.” The effect corresponding to the character string “impressed” expresses excitement with horizontal stripes and a character having a gold color. In addition, the effect corresponding to the character string “excited” effect expresses excitement with a horizontal gradation of a pink color character.

The sadness image 2300 shows effects corresponding to the character strings “dejected” and “disappointed.” The effect corresponding to the character string “dejected” expresses sadness with a vertical gradation of purple character. In addition, the effect corresponding to the character string “disappointed” expresses sadness with a character having a cool-based color. The anger image 2400 shows the effect corresponding to the character strings “screaming” and “irritated.” The effect corresponding to the character string “screaming” expresses anger with a character having a red color. In addition, the effect corresponding to the character string “irritated” expresses anger with a vertical gradation of character color from black to red.

The illustrated effect expresses the impression received from the character string and can be set by the user in advance, and thus image data including the effect when these character strings are included can be automatically generated.

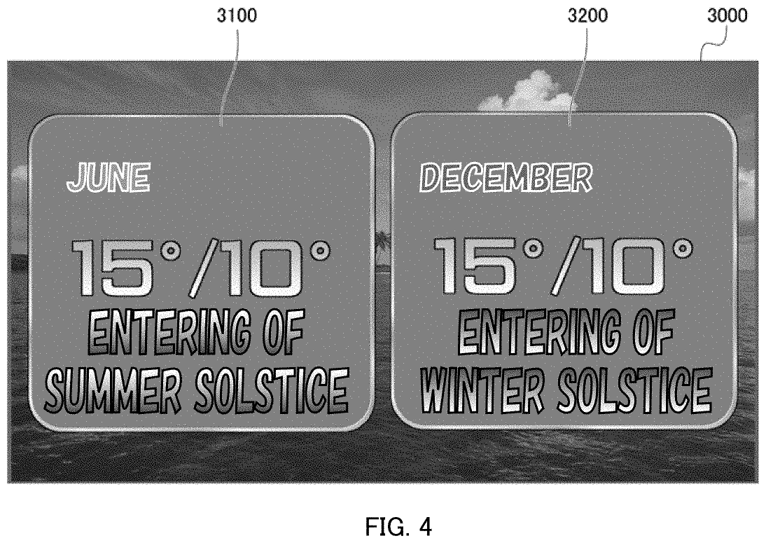

Next, the effects corresponding to the environmental characters will be described with reference to FIG. 4. FIG. 4 is a diagram showing an example of image data including an effect corresponding to the environmental characters provided in the information processing device 1.

In FIG. 4, a display screen 3000 has weather information 3100 and weather information 3200. The weather information 3100 and the weather information 3200 are display examples of image data including effects generated by the generation unit 17. The colors of the characters in the drawing are displayed in grayscale. However, each of the characters has colors described below.

The weather information 3100 indicates the effect corresponding to the character strings of “June,” “15° C./10° C.” and “entering of summer solstice. The effect corresponding to the character string “June” expresses a rainy season with the character having a light blue color. The effect corresponding to the character string “15° C./10° C.” expresses the cold in combination with “June” with the character that expresses the maximum temperature and the minimum temperature having a vertical gradation of indigo color. In addition, the effect corresponding to the character string “entering of summer solstice” expresses the change of seasons with a color of a character “summer solstice” having a gradation of yellow and purple. A particle “of” is caused to be less noticeable than other characters by reducing the size of the character to make it white. In addition, the effect “entering” expresses the heat by using a red gradation.

The weather information 3200 indicates the effect corresponding to the character strings “December,” “15° C./10° C.” and “entering of winter solstice.” The effect corresponding to the character string “December” expresses the cold with the character having an indigo color. The effect corresponding to the character string “15° C./10° C.” expresses warmth with the characters of the maximum temperature and the minimum temperature having a color shown by a gradation of red in a vertical direction in combination with “December.” Although the character string that expresses temperature itself is the same as the character string in the weather information 3100, the character string that expresses temperature itself expresses in combination with December that a person feels warm for December. In addition, the effect corresponding to the character string “entering of winter solstice” expresses the change of seasons with the character of “winter solstice” having a color shown by a gradation of purple and yellow. A particle “of” is made less noticeable than other characters by reducing the size of the character to make it white. In addition, an effect corresponding to the character string “entering” expresses the cold with a blue gradation.

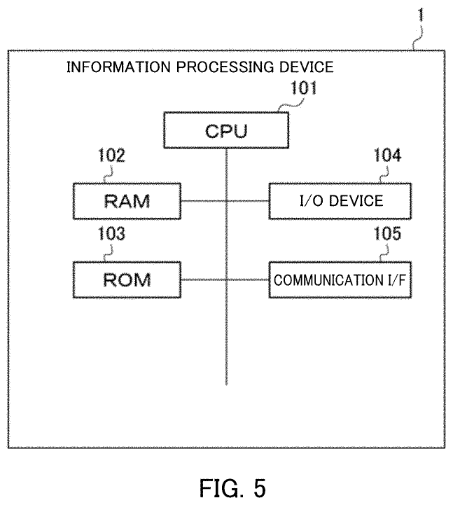

Next, the hardware configuration of the information processing device 1 will be described with reference to FIG. 5. FIG. 5 is a block diagram showing an example of the hardware configuration of the information processing device 1.

The information processing device 1 includes a CPU (Central Processing Unit) 101, a RAM (Random Access Memory) 102, a ROM (Read Only Memory) 103, an I/O device 104, and a communication I/F (Interface) 105. The information processing device 1 is a device that executes the information processing program described with reference to FIG. 1.

The CPU 101 controls the user terminal by executing an information processing program stored in the RAM 102 or the ROM 103. The information processing program is acquired from, for example, a recording medium on which the program is recorded, a program distribution server via a network, installed in the ROM 103, read from the CPU 101, and executed.

The I/O device 104 has an operation input function and a display function (operation display function). The I/O device 104 is, for example, a touch panel. The touch panel enables the user of the information processing device 1 to input operations using a fingertip, a stylus, for example. A situation where the I/O device 104 in the example uses a touch panel having an operation display function is described. However, the I/O device 104 may separately have a display device having a display function and an operation input device having an operation input function. In such a configuration, a display screen of the touch panel serves as a display screen of the display device, and an operation of the touch panel may be performed as an operation of the operation input device. The I/O device 104 may be executed by various forms such as a head-mounted type, a glasses type, and a wristwatch type display.

The communication I/F 105 is an I/F for communication. The communication I/F 105 executes short-range wireless communication such as wireless LAN, wired LAN and infrared rays. Although the drawing shows only the communication I/F 105 as the communication I/F, the information processing device 1 may have an I/F for each communication in a plurality of communication methods.

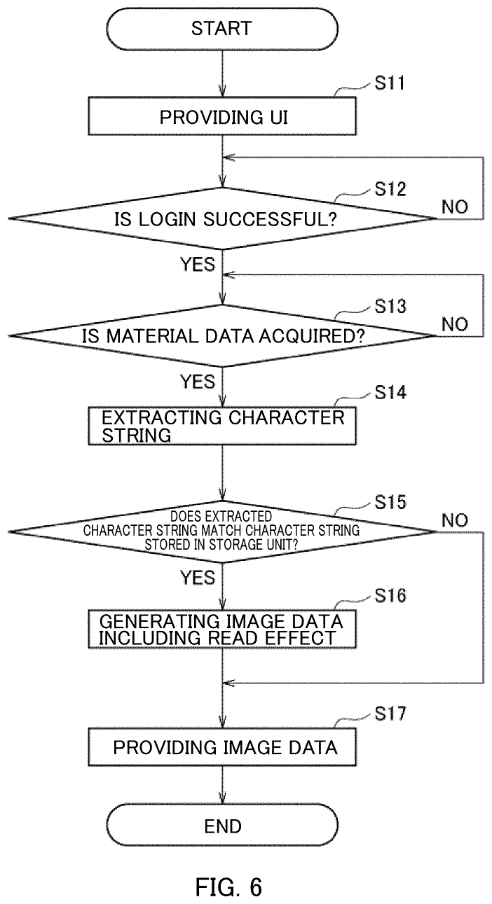

Next, operation of the information processing device 1 will be described with reference to FIG. 6. FIG. 6 is a flowchart showing an example of the operation of the information processing device 1. Although the information processing device 1 is described as a subject that performs the operations in a flowchart shown below, each of the operations can be executed by each of the functional units of the information processing device 1 described above.

In FIG. 6, the information processing device 1 provides a login screen for the user to log in, and further provides a UI for allowing the user to select a template or set the template by the user (step S11). The UI can be provided, for example, by providing a Web page to the terminal 21 that has accessed a predetermined network address of the information processing device 1.

After executing the process of step S11, the information processing device 1 determines whether or not the login of the user of the terminal 21 is successful (step S12). Whether or not the login is successful can be determined by whether or not the authentication is successful in the authentication unit 12. If it is determined that the login is not successful (step S12: NO), the information processing device 1 repeats the process of step S12 and waits for the login to succeed.

In contrast, if it is determined that the login is successful (step S12: YES), the information processing device 1 determines whether or not the material data is acquired (step S13). Whether or not the material data is acquired can be determined, for example, by whether or not the acquisition unit 14 is acquired the material data. If it is determined that the material data is not acquired (step S13: NO), the information processing device 1 repeats the process of step S13 and waits for the material data to be acquired.

In contrast, if it is determined that the material data is acquired (step S13: YES), the information processing device 1 extracts the character string included in the material data (step S14). The character string extraction is executed, for example, by decomposing the character data acquired by the acquisition unit 14 into words.

After executing the process of step S14, the information processing device 1 determines whether or not the extracted character string matches the character string stored in the storage unit 13 (step S15). If it is determined that the extracted character string matches the character string stored in the storage unit 13 (step S15: YES), the information processing device 1 reads out the effect corresponding to the character string stored in the storage unit 13, and generates image data including the read effect (step S17). In contrast, if it is determined that the extracted character string does not match the character string stored in the storage unit 13 (step S15: NO), or after executing the process of step S16, the information processing device 1 provides the image data (step S17). After executing the process of step S17, the information processing device 1 ends the operation shown in the flowchart.

The illustrated flowchart shows an example of the operation of the information processing device 1, and does not limit the operation of the information processing device 1.

The program for executing the function constituting the device described in the example is recorded on a computer-readable recording medium, and the program recorded on the recording medium is read into the computer system and executed. Therefore, the above-mentioned various processes of the example may be performed. The “computer system” herein may include hardware such as an OS and peripheral devices. Further, the “computer system” includes a homepage providing environment (or a display environment) if a WWW system is used. The “computer-readable recording medium” refers to a writable non-volatile memory such as a flexible disk, a magneto-optical disk, a ROM and a flash memory, a portable medium such as a CD-ROM, and a storage device such as a hard disk built in a computer system.

Further, the “computer-readable recording medium” also includes a medium that stores a program for a certain period of time such as a volatile memory (for example, Dynamic Random Access Memory (DRAM)) inside a computer system that serves as a server or a client when a program is transmitted via a network such as the Internet or a communication line such as a telephone line. Further, the program may be transmitted from a computer system in which this program is stored in a storage device, for example, to another computer system via a transmission medium or by a transmission wave in the transmission medium. The “transmission medium” for transmitting a program refers to a medium having a function of transmitting information such as a network (communication network) such as the Internet or a communication line (communication line) such as a telephone line. Further, the above program may be for executing a part of the above-mentioned functions. Further, it may be a so-called difference file (difference program) that executes the above-mentioned function in combination with a program already recorded in the computer system.

Although the examples have been described above with reference to the drawings, the specific configuration is not limited to the examples and includes various modifications within a range not deviating from the scope of this disclosure.

1. An information processing device comprising:
a storage unit configured to store a predetermined character string and an effect corresponding to the predetermined character string;
an acquisition unit configured to acquire character data;
a determination unit configured to determine whether or not all or a part of character string included in the character data acquired by the acquisition unit is stored in the storage unit;
a generation unit configured to generate image data including the effect when the determination unit determines that all or a part of the character string is stored in the storage unit; and
a providing unit configured to provide the image data generated by the generation unit.

2. The information processing device according to claim 1, further comprising a UI providing unit configured to provide a user interface for setting a predetermined character string and the effect, wherein
the storage unit stores a predetermined character string and the effect based on setting by an input on the user interface provided by the UI providing unit.

3. The information processing device according to claim 1, wherein the storage unit stores a character string that expresses an emotion of a person as the predetermined character string, and the generation unit generates image data including an effect corresponding to the emotion.

4. The information processing device according to claim 2, wherein the storage unit stores a character string that expresses an emotion of a person as the predetermined character string, and the generation unit generates image data including an effect corresponding to the emotion.

5. The information processing device according to claim 1, wherein the storage unit stores a character string that expresses an environment as the predetermined character string, and the generation unit generates image data including an effect corresponding to the environment.

6. The information processing device according to claim 2, wherein the storage unit stores a character string that expresses an environment as the predetermined character string, and the generation unit generates image data including an effect corresponding to the environment.

7. The information processing device according to claim 3, wherein the storage unit stores a character string that expresses an environment as the predetermined character string, and the generation unit generates image data including an effect corresponding to the environment.

8. The information processing device according to claim 1, wherein the generation unit generates image data including an effect that decorates a character string included in the character data.

9. The information processing device according to claim 2, wherein the generation unit generates image data including an effect that decorates a character string included in the character data.

10. The information processing device according to claim 3, wherein the generation unit generates image data including an effect that decorates a character string included in the character data.

11. The information processing device according to claim 5, wherein the generation unit generates image data including an effect that decorates a character string included in the character data.

12. The information processing device according to claim 1, wherein
the storage unit stores effects corresponding to a first character string that expresses a first state as the predetermined character string, and a second character string that expresses a second state and an effect corresponding to a combination of the first character string and the second character string, and
the determination unit determines whether or not a part of character strings included in the character data is included in the first character string and the second character string, and the generation unit generates image data including an effect corresponding to the combination when the determination unit determines that a part of the character data is included in the first character string, and another part of the character data is included in the second character string.

13. The information processing device according to claim 2, wherein
the storage unit stores effects corresponding to a first character string that expresses a first state as the predetermined character string, and a second character string that expresses a second state and an effect corresponding to a combination of the first character string and the second character string, and
the determination unit determines whether or not a part of character strings included in the character data is included in the first character string and the second character string, and the generation unit generates image data including an effect corresponding to the combination when the determination unit determines that a part of the character data is included in the first character string, and another part of the character data is included in the second character string.

14. The information processing device according to claim 3, wherein
the storage unit stores effects corresponding to a first character string that expresses a first state as the predetermined character string, and a second character string that expresses a second state and an effect corresponding to a combination of the first character string and the second character string, and
the determination unit determines whether or not a part of character strings included in the character data is included in the first character string and the second character string, and the generation unit generates image data including an effect corresponding to the combination when the determination unit determines that a part of the character data is included in the first character string, and another part of the character data is included in the second character string.

15. The information processing device according to claim 5, wherein
the storage unit stores effects corresponding to a first character string that expresses a first state as the predetermined character string, and a second character string that expresses a second state and an effect corresponding to a combination of the first character string and the second character string, and
the determination unit determines whether or not a part of character strings included in the character data is included in the first character string and the second character string, and the generation unit generates image data including an effect corresponding to the combination when the determination unit determines that a part of the character data is included in the first character string, and another part of the character data is included in the second character string.

16. The information processing device according to claim 8, wherein
the storage unit stores effects corresponding to a first character string that expresses a first state as the predetermined character string, and a second character string that expresses a second state and an effect corresponding to a combination of the first character string and the second character string, and
the determination unit determines whether or not a part of character strings included in the character data is included in the first character string and the second character string, and the generation unit generates image data including an effect corresponding to the combination when the determination unit determines that a part of the character data is included in the first character string, and another part of the character data is included in the second character string.

17. The information processing device according to claim 1, wherein the acquisition unit acquires an image including character data, and the determination unit extracts character data from the image acquired by the acquisition unit, and determines whether or not all or a part of character strings included in the extracted character data are stored in the storage unit.

18. The information processing device according to claim 1, wherein the generation unit generates image data concerning a ticker image including the effect, and the providing unit provides the image data to a processing device that processes the ticker image.

19. An information processing method executed in an information processor, the information processing method comprising:
storing a predetermined character string and an effect corresponding to the predetermined character string;
acquiring character data;
determining whether all or a part of a character string included in character data acquired is stored;
generating image data including the effect when a determination unit determines that all or a part of the character string is stored; and
providing the generated image data.

20. A non-transitory recording medium storing therein an information processing program for causing a computer to execute the functions of:
storing a predetermined character string and an effect corresponding to the predetermined character string;
acquiring character data;
determining whether or not all or a part of a character string included in character data acquired is stored;
generating image data including the effect when it is determined that all or a part of the character string is stored; and
providing the generated image data.
